(19) United States
(12) Patent Application Publication
(10) Pub. No.: US 2007/0130454 A1
(43) Pub. Date: Jun. 7, 2007

(54) Hardware identification utility

(76) Inventor: Carl M. Bentley, Port Salerno, FL (US)

Correspondence Address: L. Zale Patent Law Offices, 334 South Franklin Street, Wilkes-Barre, PA, 18702, US

(21) Appl. No.: 11/633,765

(22) Filed: Dec. 4, 2006

Related U.S. Application Data
(60) Provisional application No. 60/742,295, filed on Dec. 5, 2005.

(51) Int. Cl. G06F 15/177

(52) U.S. Cl. 713/1

(57) ABSTRACT

An automated system employing a computer key having a number of pre-stored programs, each compatible with a different type of computer platform, are described. Computer key is designed to be plugged into a port of an unknown type of computer platform. Computer key interrogates computer platform from port to identify the platform hardware. Computer key then identifies the pre-stored software compatible with the current platform, and loads the compatible software onto platform. The software then runs on the platform, thereby automatically supporting a number of different platforms, transparent to a user.

### CROSS REFERENCES TO RELATED INVENTIONS

This application claims priority from U.S. Provisional Patent Application “Hardware Identification Utility” by Carl M. Bentley, Ser. No. 60/742,295 filed Dec. 5, 2005, hereby incorporated by reference as if set forth in its entirely herein. The present invention is also related to U.S. patent application “Portable Operating System” by Carl M. Bentley, Ser. No. 11/047,350 filed Jan. 27, 2004 hereby incorporated by reference as if set forth in its entirely herein.

### BACKGROUND OF THE INVENTION

1. Fields of the Invention

The invention relates to an automated external system for identifying a computer platform and loading the appropriate software.

2. Description of Related Art

Different computer hardware configurations (platforms) are compatible with, and are only able to run certain types of software used to manipulate user data. Therefore, if a user is away from their computer but needs to manipulate their data, they must load the proper software for it to be operational.

Since there are computer platforms available at many locations, it would be convenient to use these platforms to access data.

Therefore, there is a current need for a device which identifies the hardware component of computer platforms and provides software compatible with these hardware components to make them operational.

### SUMMARY OF THE INVENTION

The present invention may be embodied as a computer key for attaching to an electronic port of a computer platform having hardware components, for identifying at least one hardware component, the port having a plurality of contacts, the computer key comprising:
a. An electrical connection to make electrical contact with contacts of the port;
b. Message device capable of creating a message in one of a number of standard
   formats each recognized by a different computer platform, the messages requesting information relating to at least one hardware component;
c. A transmit device connected to the electrical connection and the message device, capable of sending the message created by the message device through the electrical connection, to said computer platform to identify at least one hardware component of said computer platform;
d. A receiver coupled to the connection device, capable of receiving, monitoring the connection device, and capturing signals sent through to the connection device;
e. A decoder coupled to the receiver, capable of decoding the signals captured by the receiver into decoded information at least one hardware component being used, and storing this decoded information.

The present invention may further include a configuration device coupled to the decoder, capable of reading the decoded information determining the hardware component being used, identifying software compatible with the platform being used and configuring the portable storage device to load software compatible with the hardware component being used.

The present invention may also be embodied as a method of identifying at least one hardware component of a computer platform through a port on the platform, and load compatible software comprising:
a. Inserting a computer key into said port of said computer platform having pre-stored software compatible with various types of hardware components, each stored at a various starting location of the computer key;
b. Sending one of a plurality of messages each of a different format into said port requesting information on at least one hardware component of said platform;
c. Monitoring said port for a period of time to determine if a signal has been received;
d. Decoding the received signal into decoded information;
e. Using the decoded information to identify the hardware component;
f. Identifying pre-stored software compatible with the identified hardware component;
g. Placing a jump command that points to the starting location of the compatible software specific to this hardware component.
h. Configuring the computer platform to boot from the computer key;
i. Restarting the computer platform causing it to execute the jump command at the initial load location on the computer key, thereby re-routing processing to the starting location of compatible software thereby loading the compatible software; and
j. Operating the compatible software.

### BRIEF DESCRIPTION OF THE DRAWINGS

The features and advantages of the apparatus of the invention are highlighted by the following description of some preferred embodiments of same, illustrated by way of non-limiting examples in the accompanying drawings, in which:

FIG. 1 is a schematic illustration of a system compatible with the present invention.

FIG. 2 is a partial schematic, enlarged representation of a computer key of FIG. 1.

FIGS. 3-4 together are a flowchart which illustrate the functioning of the embodiment of the present invention shown in FIGS. 1-2.

### DETAILED DESCRIPTION OF A PREFERRED EMBODIMENT

Goal

As stated in the “BACKGROUND OF THE INVENTION” above, the proper system software is required to run a given computer architecture. Therefore, if one would like to access data in a specific format, he must make sure that there is a compatible platform running compatible system software that is also compatible with the required application software. Therefore, the data has limited portability.

The goal of the present invention is to identify at least a portion of the hardware of a computer platform being used and load compatible software.

System Software

Some types of system software are only compatible with a single type of platform, such as Windows® XP by Microsoft which runs on a standard PC architecture.

However, some system software cross-platform and is written for several different computer architectures, such as Linux. The versions may have a large percentage of similar code but small sections which deviate to be compatible with the specific computer platform. The different versions of cross-platform system software are designed to run the same application software. Therefore, the same application software may be run on different platforms, allowing access to the same data format, thereby allowing greater portability.

For example, a user may make a data file with a specific application software. The user may then store it on a portable storage device and take the storage device with him/her.

At some later time, the user may need access to the data on the storage device. At this time, the user may connect the storage device to any platform running its cross-platform system software, such as a version of Linux, run the application software and access the data. This may be accomplished anywhere a version of Linux (or other cross-platform software) is running regardless of the hardware configuration.

Similarly, a user may obtain access to a computer platform. The user connects the portable storage device to the platform and determines which type of platform it is. The appropriate cross-platform system software and application software for that platform is loaded from the storage device.

The present invention operates to determine the type of computer platform, and to load the proper version of the software compatible with this computer platform.

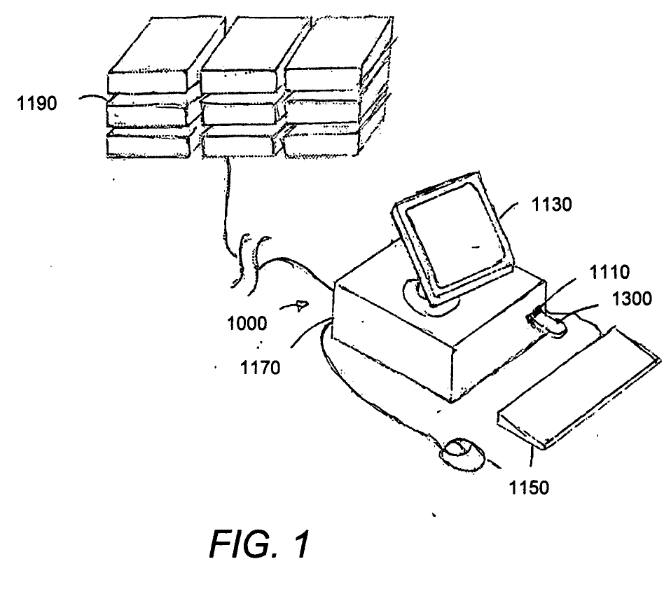

FIG. 1 shows a typical computer platform 1000. This employs a monitor 1130, input devices 1150 such as a keyboard and mouse, and a central processing unit (CPU) 1170. Platform 1000 typically has ports 1110 which may be a USB port, system bus ports or other ports allowing access to the system.

Platform 1000 may be connected by a wired network, a wireless network or a combination wired/wireless network to other computers, including a server 1190.

A computer key 1300 with pre-stored software is inserted into port 1110.

Different Initial Load Locations

For computer platforms which each have a different specific initial load location (“boot location”) uniquely predefined for this platform type, initialization proceeds as described below.

Preload Computer Key

The computer key 1300 must be properly initialized before it is used. Below are the steps required to initialize the computer key 1300 for loading, in this example, system software:
1. select a cross-platform system software to be employed;
2. determine which versions of the cross-platform system software will be supported;
3. load each version of the supported system software at starting locations on the portable storage device, each having a unique starting location pertaining to this version;
4. place a jump command at an initial load location specific to a given platform, pointing to the starting location of the stored version of cross-platform system software compatible with this platform.
   Operation

Attach preloaded computer key 1300 to a port 1110 of platform 1000;

During CMOS boot-up sequence of platform 1000, set boot device to be the port to which the computer key 1300 is attached;

Platform 1000 will load software starting at the initial load location specific to this platform, execute the jump command at this initial load location and begin loading at the start location of the software compatible with this platform.

After loading the proper version of software onto the computer platform, the software is run. Optionally, an auto execute file may load and run communications software to contact a specified server to get additional software and/or data.

Same Initial Load Location

When several incompatible platforms all look to the same initial load location, there are additional steps which should be performed to preload and operate the computer key 1300.

Check Mode

If more than one platform uses the same initial load location, computer key 1300 is designed to operate under three different modes, a Check Mode, a Configuration Mode and an Operation Mode.

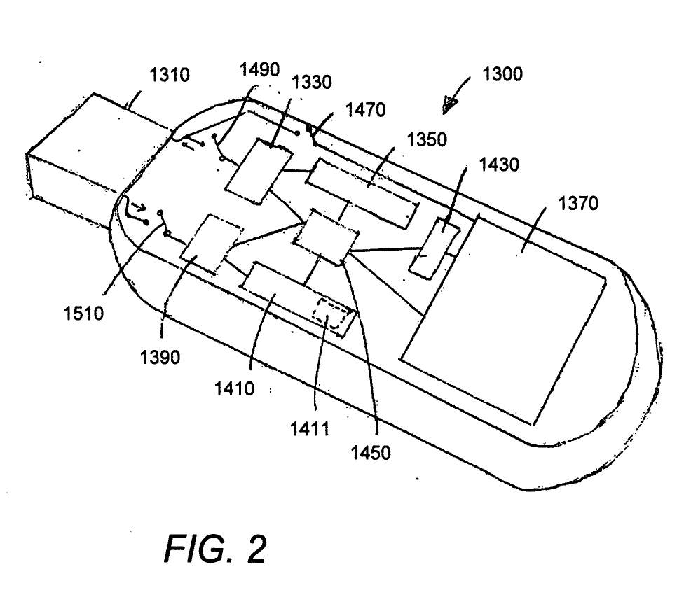

In FIG. 2 an embodiment of a Computer key 1300 consistent with the present invention is shown in schematic form. It employs a connection device 1310 which makes electrical contact with port 1110 of FIG. 1.

A transmitter 1330 and receiver 1390 are connected to connection device 1310. Switches 1470, 1490, 1510 are operated by a processor 1450 to connect/disconnect memory 1370, transmitter 1330 and receiver 1390, respectively to/from connection device 1310. Processor 1450 also activates and deactivates the elements of computer key 1300 thereby controlling their sequencing and operation.

In alternate embodiments, the functions of these devices may be grouped and incorporated into various numbers of other devices which operate to perform the same ultimate functions

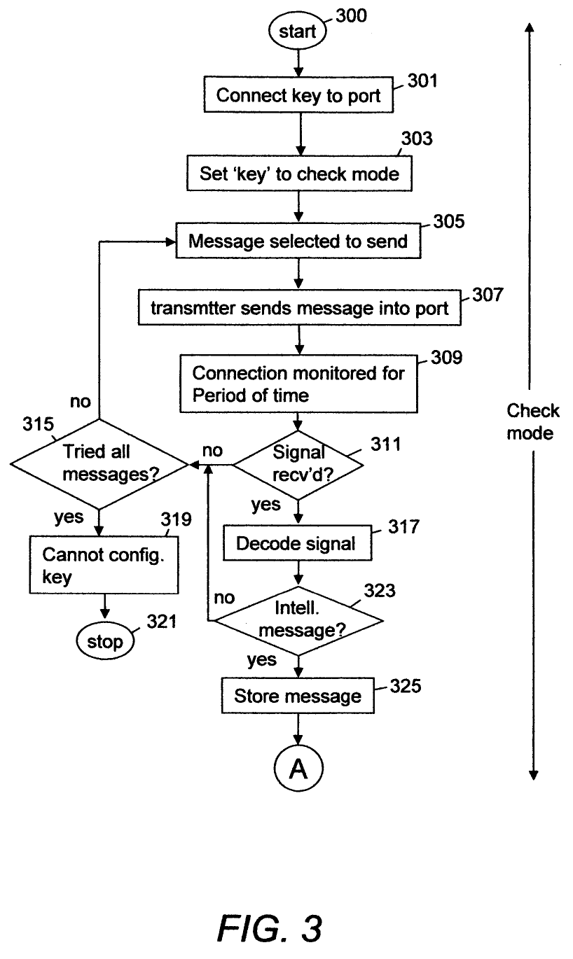

The functioning of computer key 1300 is described below with reference to FIGS. 1-4.

The process starts in step 300.

In step 301, connection device 1310 of computer key 1300 is attached to port 1110 of platform 1000.

In step 303, processor 1450 puts computer key 1300 into a check mode by closing switches 1490 and 1510 which connect transmitter 1330 and receiver 1390 to connection device 1310. Switch 1470 is opened disconnecting memory 1370 from connection device 1310. Processor 1450 activates transmit device 1330, message device 1350, memory 1370, configuration device 1430, decoder 1410 and receiver 1390.

In step 305, message device 1350 selects a message in a standard format understandable by at least one platform that has not already been sent to platform 1000.

In step 307, the message is then passed to transmitter device 1330 which creates a request signal that is sent through port 1110 via connection device 1310. These requests may be a request to identify one or more of: the CPU type, processing speed, the amount of system memory, attached storage devices, information on these devices, the input devices, printers and output devices, network connections and other system hardware.

Requests may also be sent to identify the type and version of system software running, any patches, application software, network configuration, etc. Since USB port 1110 is a two-way communications port to the heart of platform 1000, almost any information may be obtained by properly interrogating platform 1000 in the proper format.

For certain software, such as the Linux operating system, only the CPU type needs to be identified. Linux will determine the remaining hardware configuration.

In step 309, connection device 1310 is monitored by receiver 1390 for a period of time to determine if a signal has been received.

In step 311 it is determined if a signal has been received by receiver 1390.

If a signal has been received from connection device 1310 (“yes”), the signal is sent to a decoder 1410 in step 317 to decode the response. If a signal has not been received, (“no”) processing continues at step 315.

In step 315, it is determined if all of the possible messages have been tried. If so (“yes”) then a message is displayed in step 319 indicating that all possible messages have been tried without a response.

If, in step 315 (representing all supported hardware types) all messages have not been tried, (“no”) processing continues at step 305 where the next message is tried which pertains to a format compatible with a different supported hardware type.

In step 323 it is determined if the returned signal has an intelligent, decodable message. If it is (“yes”), processing continues and the message is stored in step 325 in memory 1370.

If the message is non-decodable, (“no”) processing continues at step 315.

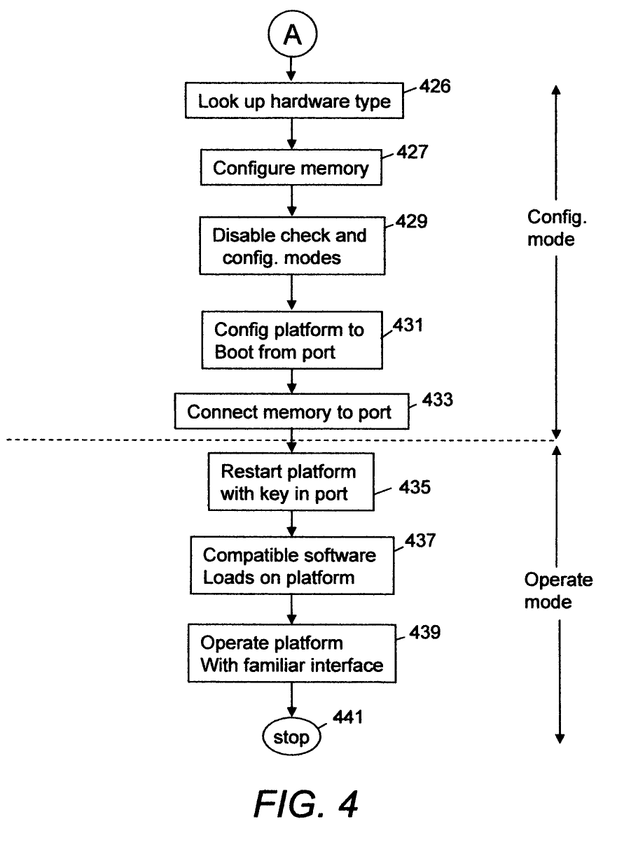

In step 426 of FIG. 4, if there are a limited number of possible responses, a lookup table 1411 may be employed to correlate the returned signal to determine hardware type.

In step 427, configuration device 1430 accesses the stored hardware type of the platform 1000, determines which piece of software is compatible with the current platform 1000. It then identifies the first location of the compatible software stored in memory 1370. Configuration device 1430 then places a jump command pointing to the first location of the compatible software at an initial load location of memory 1370.

In step 429, processor 1450 opens switches 1490 and 1510 to disconnect elements from connection device 1310, changing from the check mode to the configuration mode.

In step 431, the CMOS of platform 1000 is modified to have it boot from port 1110.

In step 433, processor 1450 closes switch 1470 connecting memory 1370 to connection device 1310.

Operation Mode

In step 435, processor 1450 indicates that a re-start of platform 1000 should be performed. Alternatively, platform 1000 may be re-started automatically with computer key 1300 inserted in port 1110.

In step 437, platform looks to the boot device on startup, which is now computer key 1300. Platform 1000 then executes the command at the initial boot location which is now a jump to the compatible software.

This software is now loaded into the memory of platform 1000.

In step 439, the compatible software runs allowing the user to operate on their own data with a familiar interface.

By sending the proper requests, it is possible to extract the hardware configuration and software information of the type of platform. This allows loading not only of compatible system software, but also of compatible applications and other software.

What is claimed is:

1. A computer key for attaching to an electronic port of a computer platform having hardware components, for identifying at least one hardware component, the port having a plurality of contacts, the computer key comprising:
a. a connection device to make electrical contact with contacts of the port;
b. a message device capable of creating a message in one of a number of standard formats each recognized by a different computer platform, the messages requesting information relating to at least one hardware component;
c. a transmitter connected to the connection device and the message device, capable of sending the message created by the message device through the connection device, to said computer platform to identify at least one hardware component of said computer platform;
d. a receiver coupled to the connection device, capable of receiving monitoring the connection device, and capturing signals sent through to the connection device;
e. a decoder coupled to the receiver, capable of decoding the signals captured by the receiver into decoded information from at least one hardware component being used.

2. The present invention may further comprise:
a configuration device coupled to the decoder, capable of reading the decoded information determining the hardware component being used, identifying software compatible with the hardware component being used and configuring the computer key [1300] to load software compatible with the hardware component being used.

3. The computer key of claim 1 further comprising:
a processor connected to the message device, the transmitter, the decoder device and the configuration device for activating and deactivating these devices causing them to perform their functions in the proper sequence.

4. The computer key of claim 1 further comprising:
a. a plurality of pre-stored pieces of software, which are each compatible with a different platform; and
b. the computer key is adapted to cause the stored piece of software compatible with the platform to be used.

5. A method of identifying at least one hardware component of a computer platform through a port on the platform, and load compatible software comprising the steps of:
a. connecting a computer key to said port of said computer platform having pre-stored software compatible with various types of hardware components, each stored at a specific starting location of the computer key;
b. sending one of a plurality of messages each of a different format into said port requesting information on at least one hardware component of said platform;
c. monitoring said port for a period of time to determine if a signal has been received;
d. decoding the received signal into decoded information;
e. using the decoded information to identify the hardware component;
f. identifying pre-stored software compatible with the identified hardware component;
g. placing a jump command that points to the starting location of compatible specific to this hardware component.

6. The method of identifying at least one hardware component of a computer platform of claim 5 further comprising the steps of:
configuring the computer platform to execute the jump command on the computer key that points to the starting location of compatible software specific to this hardware component to execute the compatible software on the computer key.

7. The method of identifying at least one hardware component of a computer platform of claim 6 further comprising the steps of:
a. restarting the computer platform causing it to execute the jump command at an initial load location on the computer key, thereby re-routing processing to the starting location of compatible software thereby loading the compatible software; and
b. operating the compatible software.

8. The method of identifying at least one hardware component of a computer platform of claim 5 wherein the step of monitoring the port comprises the step of:
monitoring the connection device connected to port.

9. A method for identifying at least one hardware component of a platform through its port using a computer key comprising the steps of:
a. attaching the computer key through the port of a computer platform,
b. creating at least one message in a standard formats recognized by a different hardware components of computer platform, the messages requesting information relating to at least one hardware component;
c. sending the message through the connection device, to said hardware component of the computer platform;
d. monitoring the connection device, and capturing signals sent through to the connection device;
e. decoding the signals captured by the receiver into decoded information at least one hardware component being used.

10. The method for identifying at least one hardware component of claim 9 further comprising the step of:
a. reading the decoded information to determine the hardware component being used,
b. identifying software compatible with the hardware component being used, and
c. configuring the computer key to load software compatible with the hardware component being used.

11. The method for identifying at least one hardware component of claim 11 further comprising the step of:
a. defining pieces of software are compatible with defined hardware components, and
b. storing the indication of which pieces of software are compatible with which hardware components.

12. The method for identifying at least one hardware component of claim 11 further comprising the step of:
executing the loaded compatible software.

13. The method for identifying at least one hardware component of claim 9 further comprising the steps of:
a. disabling the check and configuration modes, and
b. connecting the memory to port.
